(19) United States
(12) Patent Application Publication
(10) Pub. No.: US 2018/0105397 A1
(43) Pub. Date: Apr. 19, 2018

(54) ELEVATOR DOORWAY DISPLAY SYSTEMS FOR ELEVATOR CARS

(71) Applicant: Otis Elevator Company, Farmington, CT (US)

(72) Inventors: Erwann Odye, Beaulieu sur Loire (FR); Tony Huron, Saint Martin Sur Ocre (FR); Bruno Beignet, Saint Gondon (FR); Fabien Leze, Neuvy Sur Loire (FR)

(21) Appl. No.: 15/726,504

(22) Filed: Oct. 6, 2017

(30) Foreign Application Priority Data
Oct. 17, 2016 (EP) 16290200.1

(51) Int. Cl. B66B 13/26; B66B 3/00

(52) U.S. Cl. CPC B66B 13/26; B66B 3/002

(57) ABSTRACT

Elevator doorway display systems and methods of operation including an elevator car having elevator car doors, a detection device configured to detect the presence of an object or person located in a detection zone when the car doors are opened, an imaging device configured to capture an image of an opening formed by the elevator car doors when the detection device detects the presence of an object or person in the detection zone, and a display located within the elevator car and configured to display a display image when the detection device detects an object or person within the detection zone.

### CROSS-REFERENCE TO RELATED APPLICATIONS

This application claims the benefit of European Application No. 16290200.1 filed on Oct. 17, 2016, which is incorporated herein by reference in its entirety.

### BACKGROUND

The subject matter disclosed herein generally relates to elevator cars and, more particularly, elevator car rear-view camera systems.

Entering and exiting elevator cars can be difficult for persons with disabilities, such as being wheelchair bound, or for persons carrying large objects. Such persons may enter an elevator car facing toward a far wall, and once entered cannot turn around to face the elevator car doors. Thus, when the elevator car doors open at a landing (e.g., the passenger's destination floor), the passenger may not be able to tell if a person or object is on the landing and blocking their exit from the elevator car. Accordingly, one solution has been to provide mirrors located in upper corners of elevator cars to allow such passengers to determine if something or someone is blocking exit from the elevator car. It may be advantageous to provide improved mechanisms for such passengers to obtain the information they require for exiting an elevator car.

### SUMMARY

According to one embodiment, elevator doorway display systems are provided. The elevator doorway display systems include an elevator car having elevator car doors, a detection device configured to detect the presence of an object or person located in a detection zone when the car doors are opened, an imaging device configured to capture an image of an opening formed by the elevator car doors when the detection device detects the presence of an object or person in the detection zone, and a display located within the elevator car and configured to display a display image when the detection device detects an object or person within the detection zone.

In addition to one or more of the features described herein, or as an alternative, further embodiments of the elevator doorway display systems may include that the display image is at least one of an image captured by the imaging device, a notification, or a cartoon.

In addition to one or more of the features described herein, or as an alternative, further embodiments of the elevator doorway display systems may include that the detection zone is located outside of the elevator car.

In addition to one or more of the features described herein, or as an alternative, further embodiments of the elevator doorway display systems may include that the display is mounted to a wall panel of the elevator car that is opposite the car doors.

In addition to one or more of the features described herein, or as an alternative, further embodiments of the elevator doorway display systems may include a control unit configured to receive information from the detection device and the imaging device and control the display to display the display image.

In addition to one or more of the features described herein, or as an alternative, further embodiments of the elevator doorway display systems may include that the detection device and the imaging device are components of a single imaging and detection device.

In addition to one or more of the features described herein, or as an alternative, further embodiments of the elevator doorway display systems may include that the detection zone is at least one of a predetermined area, volume, distance, or range of distances from the detection device.

According to another embodiment, methods for operating elevator cars are provided. The methods include detecting an opening of elevator car doors with an elevator doorway display system, determining if an object or person is located within a detection zone, capturing an image of the opening of the elevator car doors when it is determined there is an object or person in the detection zone, and displaying a display image on a display within the elevator car indicating there is an object or person blocking an exit through the elevator car doors.

In addition to one or more of the features described herein, or as an alternative, further embodiments of the methods may include that the display image is at least one of the captured image, a notification, or a cartoon.

In addition to one or more of the features described herein, or as an alternative, further embodiments of the methods may include that the detection zone is located outside the elevator car.

In addition to one or more of the features described herein, or as an alternative, further embodiments of the methods may include that the display is mounted to a wall panel of the elevator car that is opposite the car doors.

In addition to one or more of the features described herein, or as an alternative, further embodiments of the methods may include taking no action when it is determined there is no object or person located within the detection zone.

In addition to one or more of the features described herein, or as an alternative, further embodiments of the methods may include that the detecting and capturing are performed by components of a single imaging and detection device.

In addition to one or more of the features described herein, or as an alternative, further embodiments of the methods may include that the detection zone is at least one of a predetermined area, volume, distance, or range of distances from the detection device.

Technical effects of embodiments of the present disclosure include elevator doorway display systems and methods of operation that enable automatic detection of persons or objects that may be blocking an exit from an elevator car and providing images (e.g., notifications, captured images, cartoons, etc.) on a display within the elevator car to inform a passenger that someone/something is blocking the exit.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2 is a schematic illustration of a landing floor of an elevator system with a hall call panel that may employ various embodiments of the present disclosure;

FIG. 3A is a schematic illustration of an interior of an elevator car incorporating an elevator doorway display system in accordance with an embodiment of the present disclosure as viewed from an elevator door position;

FIG. 3B is a side view schematic illustration of the elevator car and elevator doorway display system of FIG. 3A;

FIG. 3C is a schematic illustration of the elevator car and elevator doorway display system of FIG. 3A when a person is detected in a detection zone of the elevator doorway display system; and

FIG. 4 is a flow process for operation of an elevator doorway display system in accordance with an embodiment of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “##” that is shown in FIG. X may be labeled “X##” and a similar feature in FIG. Z may be labeled “Z##.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

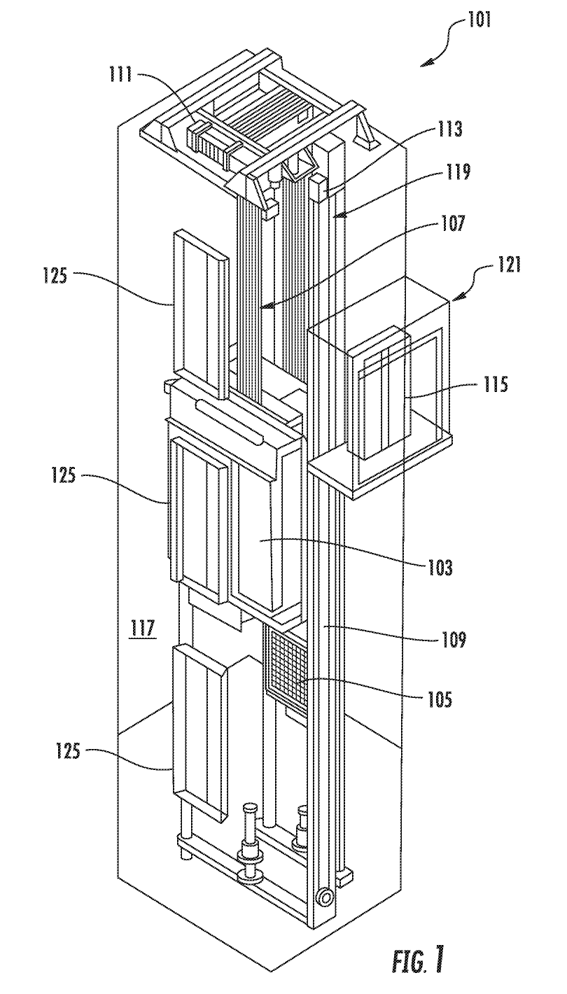

FIG. 1 is a perspective view of an elevator system 101 including an elevator car 103, a counterweight 105, a roping 107, a guide rail 109, a machine 111, a position encoder 113, and a controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position encoder 113. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor.

Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

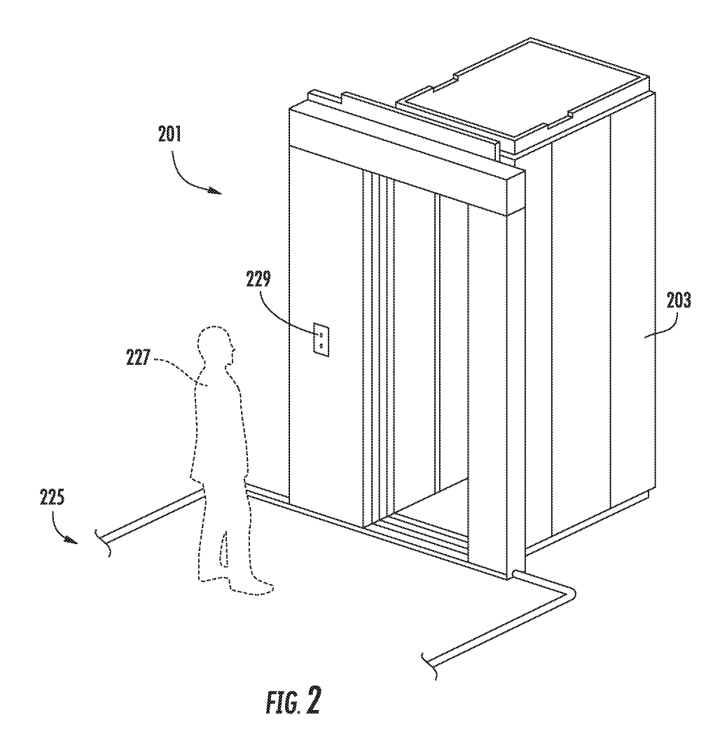

FIG. 2 is a schematic illustration of an elevator system 201 that may incorporate embodiments disclosed herein. As shown in FIG. 2, an elevator car 203 is located at a landing 225. The elevator car 203 may be called to the landing 225 by a passenger 227 that desires to travel to another floor within a building using a hall call panel 229. When the elevator car 203 arrives at the landing 225 there may be passengers already in the elevator car that wish to exit from the elevator car 203. In certain situations or circumstances, it may be difficult for the passengers already in the elevator car 203 to see if there are passengers on the landing 225 (e.g., see passenger 227). For example, a wheelchair bound person may have entered the elevator car 203 in the forward facing direction, but once in the elevator car 203, the passenger cannot turn around and face outward toward the elevator doors. As such, when the elevator doors open at a landing, the back of the wheelchair bound person may be facing the landing, and the wheelchair bound passenger will not easily be able to recognize if there is someone or something blocking their exit from the elevator car 203. Accordingly, it may be advantageous to provide camera and display systems that enable passengers within an elevator car to readily identify if there is a person or object blocking the passenger from exiting the elevator car.

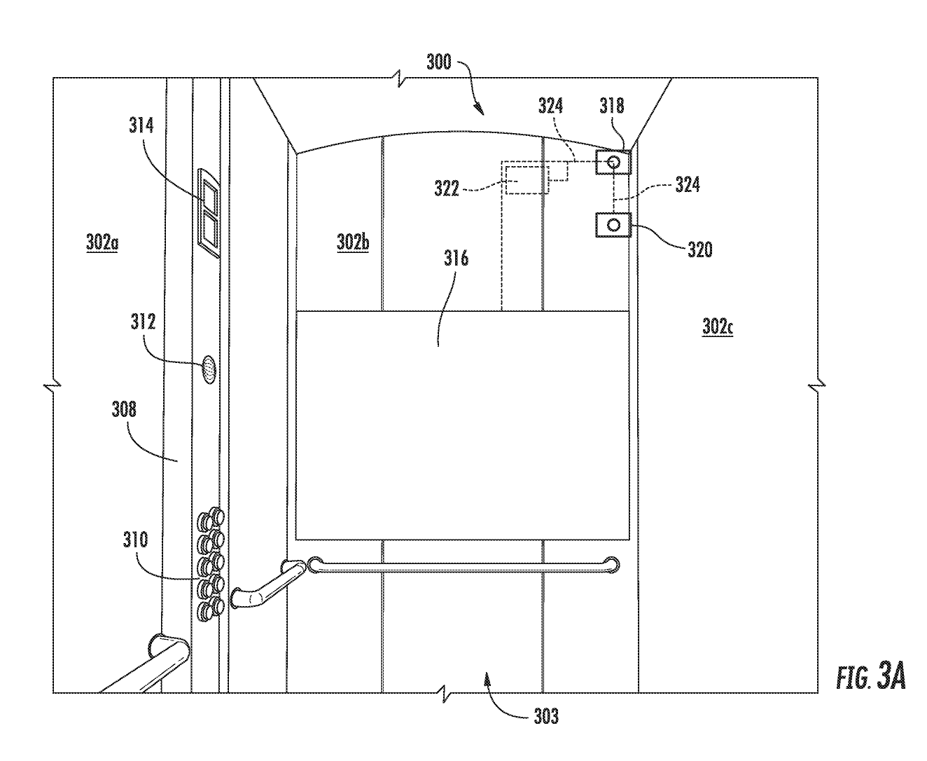

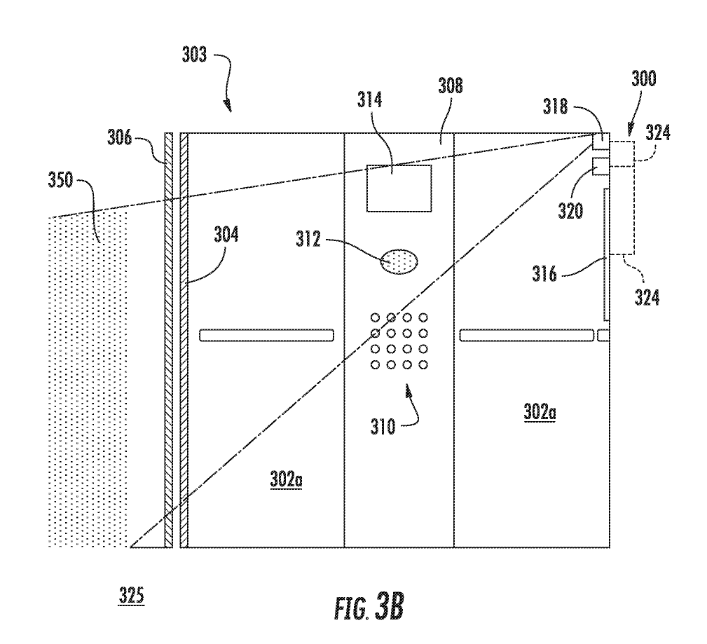

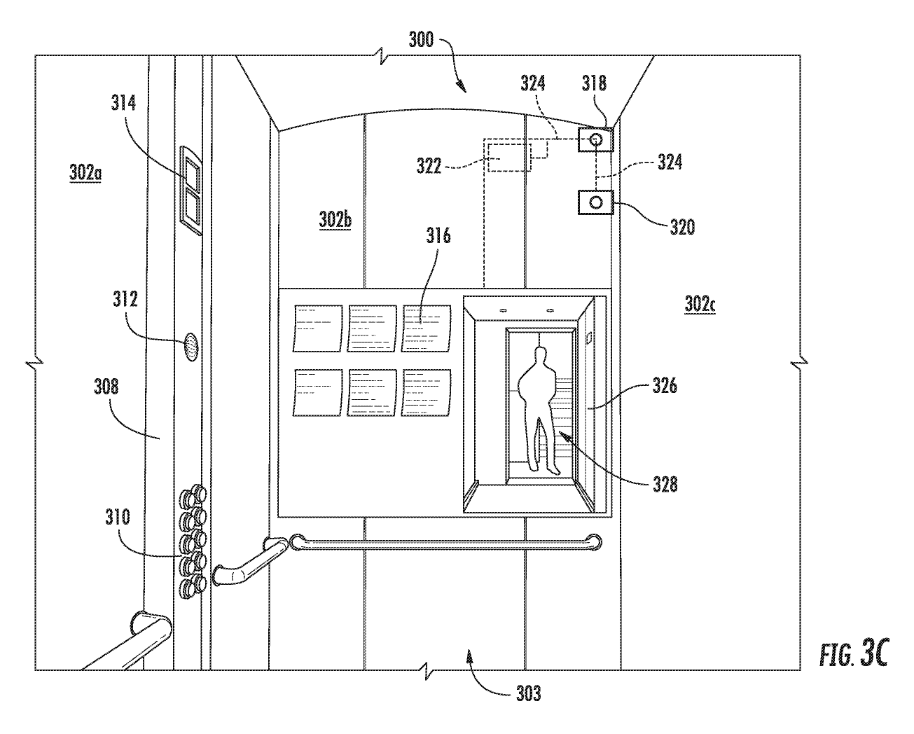

For example, turning now to FIGS. 3A-3C, schematic illustrations of an elevator doorway display system 300 in accordance with a non-limiting embodiment of the present disclosure are shown. The elevator doorway display system 300, as shown, is installed within an elevator car 303. FIG. 3A and FIG. 3C are schematic views of the interior of the elevator car 303 as viewed from an elevator car door/landing door, and thus the elevator car door/landing door is not shown. FIG. 3B is a side view of the elevator car 303 at a landing 325.

The elevator car 303 includes wall panels 302a, 302b, 302c and an elevator car door 304. When at the landing 325 (as shown in FIG. 3B), the elevator car door 304 aligns with a landing door 306 that enables access to and from the landing 325 into the elevator car 303. FIG. 3A is a schematic illustration of the interior of the elevator car 303 as viewed from the location of the landing door 306 and the elevator car door 304, as illustrated in FIG. 3B.

A first wall panel 302a of the elevator car 303 can include a car operating panel 308 including a control operating panel 310 (e.g., buttons), a speaker 312, and an operating panel display 314 (e.g., display screen). The control operating panel 310 is configured to enable passengers within the elevator car 303 to select destination floors, open/close elevator car doors, enter access codes, etc. to enable control of the elevator car 303. The speaker 312 can be used to provide audible notifications to passengers within the elevator car 303 (e.g., notification of the current floor). The operating panel display 314 can be used to provide a visual indication or notification to passengers within the elevator car 303, such as current floor, and/or can be used to display other information and/or images, including, but not limited to, weather, commercials, tenant information, etc.

As shown, a second wall panel 302b can be a wall panel that is opposite an elevator car door 304/landing door 306 (see FIG. 3B). A display 316 of the elevator doorway display system 300 can be mounted to and/or integrated into the second wall panel 302b. The display 316 can be a television or other display screen positioned within the elevator car 303 to provide various information and/or entertainment within the elevator car 303. Further, the display 316 is part of the elevator doorway display system 300 as described herein.

The elevator doorway display system 300 of the currently described embodiment, and as shown in FIGS. 3A-3C, includes a detection device 318 and an imaging device 320. The detection device 318, as shown, is located in an upper corner of the elevator car 303 and is positioned such that it can detect the presence of a person or object that is at the landing 325 when the elevator car doors 304 and the landing doors 306 are opened. Although shown in an upper corner of the elevator car, the detection device is not so limited and can be positioned anywhere within or on the elevator car 303 and/or outside the elevator car 303 (e.g., located on a landing) such that it can detect the presence of an object or person located just outside of the elevator car 303 when the doors 304, 306 are opened. The imaging device 320 can be a camera that can capture an image of the doorway when the doors 304, 306 are opened. The imaging device 320 can be a camera or other image capture device that can capture live or real-time images or video. In some embodiments, the detection device 318 and the imaging device 320 can be the same device or housed in a single housing. One or both of the detection device 318 and the imaging device 320 can include a controller, processor, microprocessor, etc. that can enable control and processing as described herein. Alternatively or in combination therewith, a control unit 322 can be configured to receive signals, data, and/or information from one or both of the detection device 318 and the imaging device 320.

As shown, the control unit 322, the detection device 318, the imaging device 320, and the display 316 can be in communication over a communication network 324. The communication network 324, although shown as dashed lines and indicating wiring, can be configured as a wireless network, or a combination of wired and wireless communication mechanisms. In some embodiments, the communication network 324 can enable the control unit 322 to operably control one or more of the detection device 318, the imaging device 320, and the display 316.

In operation, the elevator doorway display system 300 is configured to provide information to a passenger within the elevator car regarding the environment of a landing when the elevator car doors 304 open at the landing. For example, when the elevator car doors 304 open, the detection device 318 can detect the presence of a person or object that is obstructing an exit from the elevator car. As schematically shown in FIG. 3B the detection device 318 can be configured to determine if a person or object is located within a detection zone 350. The detection zone 350 can be a predetermined area, volume, distance, or range of distances from the detection device 318 that is monitored by the detection device 318. The detection zone 350 can be preset or predetermined to optimize the elevator doorway display system 300 such that persons/objects within the elevator car 303 do not improperly trigger the system and/or that persons/objects that are outside the elevator car 303 but are far enough away to not block exit from the elevator car 303 do not trigger the system. In other embodiments, the detection zone 350 can be configured with other dimensions that include greater or lesser areas or volumes. For example, in some embodiments, the detection zone 350 can be configured to include a portion of the elevator car that is proximate or immediately within the elevator car doors 304 such that, for example, a person standing behind a wheelchair bound passenger can trigger the elevator doorway display system 300 to display an image to aid the wheelchair bound passenger. Thus, the detection zone 350 is not so limited to that shown and described in FIG. 3B, and those of skill in the art will appreciate that various configurations and settings for the detection zone 350 are possible without departing from the scope of the present disclosure.

When a detection is made by the detection device 318, the imaging device 320 can activate and capture an image or video of the opening and convey such image/video to the display 316 to be visually shown on the display. Accordingly, a passenger within the elevator 303 that is facing the display 316 and cannot see or has difficulty seeing the opening of the elevator car doors 304 can be provided with information and/or images that provide the information that the passenger is lacking.

For example, as shown in FIG. 3C, illustrated is a schematic picture of the display 316 displaying an image 326 that indicates that there is a waiting passenger 328 that is outside the elevator car doors 304 when the elevator car doors 304 opened. That is, the detection device 318 detects that the waiting passenger 328 is present and activates the imaging device 320. The imaging device 320 then sends a captured image to the display 316 for producing the image 326 that shows a live or current image of the environment outside the elevator car 303.

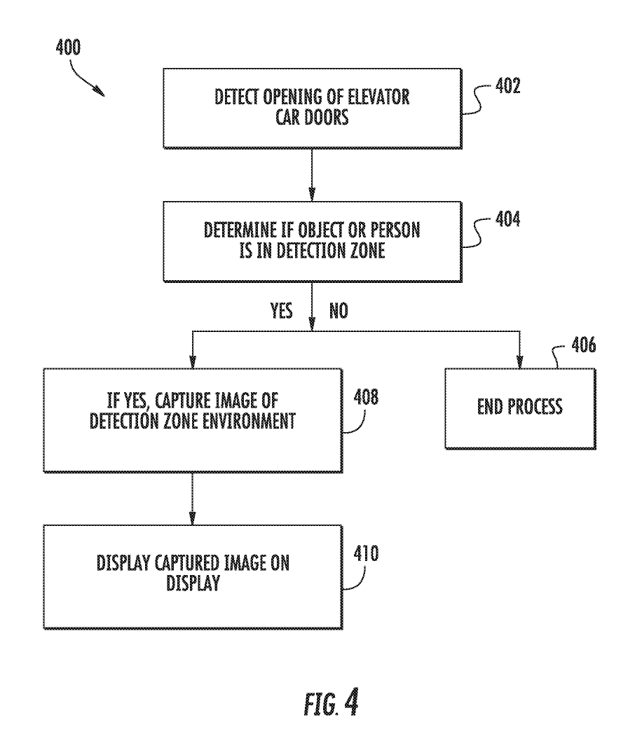

Turning now to FIG. 4, a flow process 400 for displaying information regarding an elevator landing within an elevator car in accordance with an embodiment of the present disclosure is shown. The flow process 400 can be performed with a system as shown and described above or with other systems configured with appropriate components to carry out the described flow process.

At block 402, a detection or determination of elevator car doors being opened is performed. The detection or determination can be a visual determination, such as using the detection device and/or the imaging device described above. Alternatively, a simple switch may be configured to relay a signal to an elevator doorway display system in accordance with the present disclosure. In some embodiments, the switch can relay a digital signal that indicates that a detection process (e.g., block 404) should be performed or may be an electrical switch that turns on or otherwise activates an elevator doorway display system. That is, the detection or determination regarding the opening of the elevator car doors can take various forms or configurations as will be appreciated by those of skill in the art.

At block 404, when the elevator car doors are opened (as detected at block 402), the system can determine if a person or object is located outside the elevator car doors or otherwise located behind a wheelchair bound passenger (e.g., within the elevator car and behind such wheelchair bound passenger). For example, a detection device as described above can be used to determine the presence of an object or person that is located within a certain distance or area relative to the elevator car doors. In some embodiments, the detection device can be calibrated or otherwise configured to only detect persons or objects within a specific distance, area, or volume relative to the elevator car doors (i.e., a detection zone). Accordingly, in such a configuration, objects or people that are outside of the predetermined detection zone may be ignored or otherwise not influence or otherwise impact the flow process 400 or operation of the elevator doorway display system as described herein.

If nothing is detected at block 404, then the flow process 400 ends at block 406. However, if an object or person is detected by the detection device within the detection zone at block 404, the flow process 400 continues to block 408. At block 408, the elevator doorway display system captures an image of the environment through the doorway of the elevator (e.g., an image of the detection zone). The image can be captured by the detection device used for detection at block 404 or can be a separate imaging device as described above. The image can be a still image or a video image.

At block 410, a display can be used to display the image that is captured at block 408. As such, a passenger within the elevator car can look at the display and see if someone or something is blocking an exit from the elevator car, even if the passenger is looking away from the elevator car doors (e.g., in a wheelchair and cannot easily turn around).

The image can be displayed for a predetermined amount of time, and then cease being displayed. In some embodiments a timer can be used. In other embodiments, the display image can remain displayed as long as the elevator car doors remain open. Then, when the elevator car doors begin to close, or fully close, the image can cease being displayed.

Although shown and described with respect to a limited number of illustrative embodiments, the present disclosure is not to be limited thereby. For example, although shown and described as capturing a live image, such live image need not be displayed on the display. Instead a notification, cartoon, or other indicator can be displayed on the display, without having to record or otherwise capture an image of a person that is within the detection zone. In such embodiments, the imaging device can be eliminated or fully incorporated into the detection device, as described above.

Further, although shown with the display mounted to a wall panel of the elevator car, the display is not so limited. For example, a display that is part of the car operating panel can be used to display an image or information regarding an object or person within the detection zone. In other embodiments, a display can be mounted in other locations within the elevator car, such as mounted in an upper corner of the elevator car. Further, as noted above, the location of the detection device and/or the location of the imaging device are not limited to those locations shown and described. For example, in some embodiments, one or both of the detection device and/or the imaging device can be located proximate the elevator car door(s).

Further, in some non-limiting embodiments, the detection device and/or the imaging device can be located on the landing and the display within the elevator car can be in communication therewith. In such an example, each landing within a building may have a specific detection device and/or imaging device that is in communication with a control unit of the elevator car, and then when the elevator car arrives at a particular landing, the detection device can be used to activate the system similar to that described above. In another example, a detection device can be a pressure plate or sensor located on the floor of the landing, and when weight is detected thereon, when an elevator car arrives at such landing, the elevator doorway display system can be activated to provide an image or information regarding the presence of a person or object blocking an exit from the elevator car.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

What is claimed is:

1. An elevator doorway display system comprising:
an elevator car having elevator car doors;
a detection device configured to detect the presence of an object or person located in a detection zone when the car doors are opened;
an imaging device configured to capture an image of an opening formed by the elevator car doors when the detection device detects the presence of an object or person in the detection zone; and
a display located within the elevator car and configured to display a display image when the detection device detects an object or person within the detection zone.

2. The elevator doorway display system of claim 1, wherein the display image is at least one of an image captured by the imaging device, a notification, or a cartoon.

3. The elevator doorway display system of claim 1, wherein the detection zone is located outside of the elevator car.

4. The elevator doorway display system of claim 1, wherein the display is mounted to a wall panel of the elevator car that is opposite the car doors.

5. The elevator doorway display system of claim 1, further comprising a control unit configured to receive information from the detection device and the imaging device and control the display to display the display image.

6. The elevator doorway display system of claim 1, wherein the detection device and the imaging device are components of a single imaging and detection device.

7. The elevator doorway display system of claim 1, wherein the detection zone is at least one of a predetermined area, volume, distance, or range of distances from the detection device.

8. A method for operating an elevator car, the method comprising:
detecting an opening of elevator car doors with an elevator doorway display system;
determining if an object or person is located within a detection zone;
capturing an image of the opening of the elevator car doors when it is determined there is an object or person in the detection zone; and
displaying a display image on a display within the elevator car indicating there is an object or person blocking an exit through the elevator car doors.

9. The method of claim 8, wherein the display image is at least one of the captured image, a notification, or a cartoon.

10. The method of claim 8, wherein the detection zone is located outside the elevator car.

11. The method of claim 8, wherein the display is mounted to a wall panel of the elevator car that is opposite the car doors.

12. The method of claim 8, further comprising taking no action when it is determined there is no object or person located within the detection zone.

13. The method of claim 8, wherein the detecting and capturing are performed by components of a single imaging and detection device.

14. The method of claim 8, wherein the detection zone is at least one of a predetermined area, volume, distance, or range of distances from the detection device.
